(19) United States
(12) Patent Application Publication
(10) Pub. No.: US 2017/0357336 A1
(43) Pub. Date: Dec. 14, 2017

(54) Remote computer mouse by camera and laser pointer

(71) Applicant: Evan McNeil, Pleasanton, CA (US)

(72) Inventor: Evan McNeil, Pleasanton, CA (US)

(21) Appl. No.: 15/177,275

(22) Filed: Jun. 8, 2016

(51) Int. Cl. G06F 3/038; G06F 3/00; G06F 3/0354; G06F 3/0346

(52) U.S. Cl. CPC G06F 3/0386; G06F 3/0346; G06F 3/005; G06F 3/03542; G06F 2203/0383; G06F 2203/0384

(57) ABSTRACT

An apparatus and methods for remote controlling of mouse cursor and imitating its function is disclosed. The apparatus comprises of a camera module, one or more processors, one or more memories, a communication interface, a switch for setting work mode and image processing programs stored in the memories. This apparatus has two working modes which are set by the switch: camera mode and mouse mode. In camera mode, the apparatus works as a regular digital camera. In mouse mode, the apparatus works with a laser pointer to play functions of a mouse. It captures the image of a target area which is overlaid with the beam spot of the laser pointer, then analyzes the trace pattern and detects the dynamic properties of the beam spot characterized by primary and secondary attributes, and further performs predefined mouse when communicating with a computer through wired or wireless communication.

### BACKGROUND OF THE INVENTION

### 1. Field of the Invention

This invention relates to machine vision, human-computer interfaces and computer peripherals. It comprises optical lens, image sensor, image processing hardware with embedded software and I/O parts.

### 2. Description of the Related Art

The Computer is becoming more and more integral in human life. The mouse is one of most frequently used interface for human-computer interaction. There are situations where it is difficult or inconvenient to operate the computer using a traditional mouse, especially in the situations when presentation is performed on a projector or a big screen display while the presenter is away from the computer where the presentation materials reside and need to be constantly accessed throughout the presentation.

There are several approaches known in the art to use a camera and a laser pointer to initiate the mouse operation so the computer can be controlled remotely.

In the Patent Publication U.S. Pat. No. 7,683,881 B2 “VISUAL INPUT POINTING DEVICE FOR INTERACTIVE DISPLAY SYSTEM” by Sun et al. an interactive presentation system using a presentation computer, a computer controlled image projector and a projection screen is disclosed in which control of the presentation computer is accomplished by using a wireless optical pointer that projects an encoded control cursor onto the projection screen. The projected screen images are monitored by a video camera, and the control cursor is scanned, detected and decoded for emulation various keyboard commands and/or pointing device (mouse, touch pad, track ball) position-dependent cursor operations, e.g., select, move, left click, right click and double click. The control cursor is characterized by one or more primary attributes, for example image intensity or image repetition (blink) rate. The control cursor is also characterized by one or more secondary attributes, for example pixel area (image size), color, or pattern (image shape), that correspond with specific computer commands. Preferably, the image properties of the primary attributes and secondary attributes are mutually exclusive with respect to each other, respectively, thus allowing cursor-related processing operations to be performed conditionally and independently.

In the Patent Publication U.S. Pat. No. 6,704,000 B2 “METHOD FOR REMOTE COMPUTER OPERATION VIA A WIRELESS OPTICAL DEVICE” by Carpenter, a method for remote operation of a computer having a cursor, via a wireless optical device is disclosed. The disclosed method comprises projecting a computer output display onto projection surface via a projecting means, generating an optical point on a desired cursor position on the projected image via the wireless optical device, capturing the image and optical point and transmitting this data to the computer, positioning the cursor on the projected image within a predefined distance of the position of the optical point, measuring a dwell time and executing a computer command when the dwell time exceeds predefined length of time. The executed computer commands may comprise any of a single left-mouse-click, double left-mouse-click, right-mouse-click, a mouse command, or a keyboard command.

In the Patent Publication U.S. Pat. No. 7,830,362 B2 “LASER AND DIGITAL CAMERA COMPUTER POINTER DEVICE SYSTEM” by Finley, a system consisting of methods for processing, image capturing, transferring, and displaying is disclosed. What have been also disclosed for processing are software modules for analysis of captured images. By using a combination of a macro and micro algorithms, the position of the laser point can be determined on captured images at all time. Wherein the macro-algorithms is adaptable and controls weights on likely contributions of each of the micro algorithms, the micro-algorithms include a number of different statistical and signal processing techniques which each independently analyze a camera data stream, and the analysis module further uses the position information determined from the captured images to provide control signals to the operating system or to other software modules within the processing means.

The complete system introduced by above approaches would all need two separate and interfaced computers: one for presentation material hosting and display, another for image processing on compounded with laser beam spot traces captured by camera. Another common characteristic in above mentioned approached is the requirement of a special laser pointer. Even though different encoding methods for predefined functions are integrated for mouse commands such as size, color, pattern of laser beam or dwell time, it would still be difficult to use an off-the-shelf laser pointer for the purpose.

### SUMMARY OF THE INVENTION

To address disadvantage in above mentioned systems, embodiments of the present invention provide a method and apparatus to remotely control a computer by mouse functions, and further execute such functions in the light of characteristics of the laser beam spot.

In present invention, the state of art embodiments are used to capture, display, and transport the compounded images that combines the original image with the laser beam spot, so that the compounded image data is analyzed and converted into commands to execute the intended mouse operations.

In further embodiments of the present invention, a method and an apparatus to track the trace of the beam spot is established by analyzing the compounded image captured by the apparatus.

In further embodiments of the present invention, a method and an apparatus to reconstruct coordinates of active area of captured image is established to compare and match the coordinates of target displayer.

In further embodiments of the present invention, a method and an apparatus to execute a predefined mouse function is established by decoding beam spot trace pattern and intensity modulation of the spot.

In further embodiments of the present invention, a method and an apparatus is established to output the cursor coordinate and predefined mouse function to a computer through a wired or wireless communication.

In further embodiments of the present invention, a method and an apparatus is established to switch the system function between imitating a mouse and regular digital camera.

In further embodiments of the present invention, the system comprises an apparatus and a laser pointer. The apparatus includes optical lens, image sensor, one or more processors, a memory, one or more programs stored to the memory to be executed by the one or more processors and I/O parts. The laser pointer is off-the-shelf product which is readily available everywhere.

### BRIEF DESCRIPTION OF THE DRAWINGS

FIG. 1 illustrates an electronic device including a camera module, a processor, a memory, a switch, a communication interface and a program according to embodiments of the present disclosure;

FIGS. 2A and 2B illustrate a camera module, which comprises lens and image sensor, with or without an IR-cut filter;

FIGS. 3A and 3B illustrate a layout of the electronic device, a laser pointer, a computer and a target area according to embodiments of the present disclosure;

FIG. 4 illustrates the working flow chart for the electronic device working in one of 2 modes according to embodiments of the present disclosure;

FIG. 5 illustrates the working flow chart of the electronic device working at mouse mode according to embodiments of the present disclosure;

FIG. 6 illustrates the working flow chart of the electronic device working at camera mode according to embodiments of the present disclosure;

FIG. 7 illustrates an example of an encoded control signal produced by a laser pointer, which corresponds to mouse command “left button single-click” according to embodiments of the present disclosure;

FIG. 8 illustrates an example of an encoded control signal produced by an optical pointer, which corresponds to mouse command “left button double-click” according to embodiments of the present disclosure;

FIG. 9 illustrates an example of an encoded control signal produced by an optical pointer, which corresponds to the command “right button single-click” according to embodiments of the present disclosure;

FIG. 10 illustrates an example of an encoded control signal produced by an optical pointer, which corresponds to the command “left button drag” according to embodiments of the present disclosure;

FIG. 11 illustrates an example of an encoded control signal produced by an optical pointer, which corresponds to the command “scroll right” according to embodiments of the present disclosure;

FIG. 12 illustrates an example of an encoded control signal produced by an optical pointer, which corresponds to the command “scroll left” according to embodiments of the present disclosure;

FIG. 13 illustrates an example of an encoded control signal produced by an optical pointer, which corresponds to the command “scroll up” according to embodiments of the present disclosure;

FIG. 14 illustrates an example of an encoded control signal produced by an optical pointer, which corresponds to the command “scroll down” according to embodiments of the present disclosure;

FIG. 15 illustrates an example of the installation of the electronic device which is embedded into a projector according to embodiments of the present disclosure.

### DETAILED DESCRIPTION

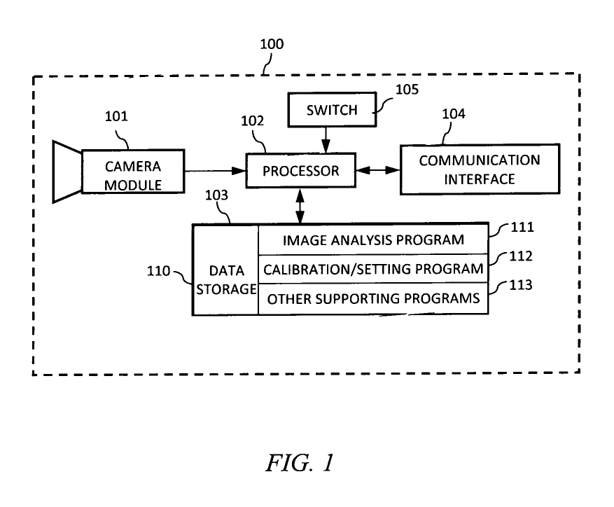

FIG. 1 through 12, discussed below, and the various embodiments used to describe the principles of the present disclosure in this patent document are by way of illustration only and should not be construed in any way to limit the scope of the disclosure.

FIG. 1 is a block diagram of an electronic device 100 working with laser pointer for remote controlling of mouse cursor functions of a computer according to embodiments of the present disclosure.

Referring to FIG. 1, the electronic device 100 includes a camera module 101, a processor 102, a memory 103, a communication interface 104 and a switch 105. A plurality of processors 102 and a plurality of memories 103 can be equipped.

The memory 103 stores captured image data 110, image processing program 111, calibration and pre-setting data 112, and other supporting programs 113.

The image processing program 111 is to analyze captured image to acquire encoded bean spot coordinates and actual spot trace, and the compare to predefined intensity modulation and trace pattern.

The calibration and pre-setting data 112 is to perform coordinate calibration so that the captured image coordinates are converted into and aligned with the coordinates of target area. Such calibration data is then saved and can be customized per users' preferences.

The other supporting programs 113 include system initialization, mode setting, standard communication between computer and camera.

The communication interface 104 provides a wired or wireless communication method between the electronic device and a computer. It could be one of USB (Universal Series Bus), RS232, PS2, blue tooth or Wi-Fi.

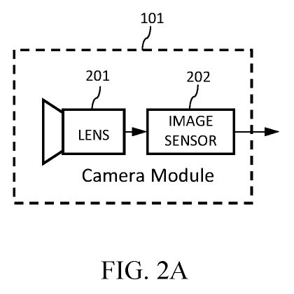

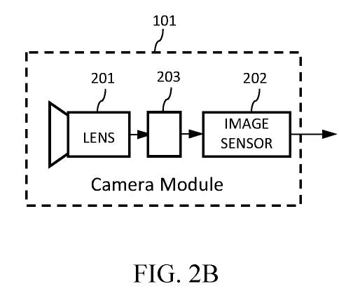

The camera module 101 comprises lens 201 and image sensor 202 as illustrated in FIG. 2A. The image 202 could be one of CCD sensor and CMOS sensor. Since the image sensor is more sensitive in near infer-red range, an extra optical element 203 is normally needed for better signal-to-noise ratio. Such element 203 can be IR-cut filter or blue glass which reflects or absorbs the infra-red light as illustrated in FIG. 2B.

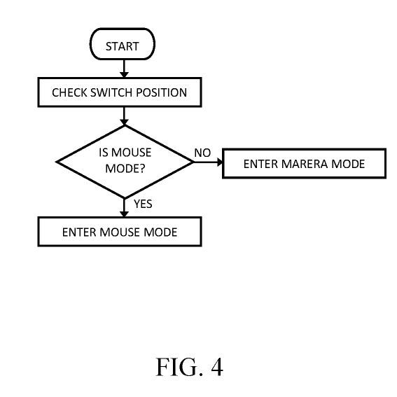

The electronic device has two operation modes: mouse mode and camera mode. Such mode is set by the switch 105. FIG. 4 illustrates the flow chart for these two working modes.

In camera mode, the electronic device performs all the functions of regular digital camera in addition to functions for coordinate calibration and parameter setting.

In mouse mode, the electronic device works with laser pointer to perform all the function of a regular computer mouse.

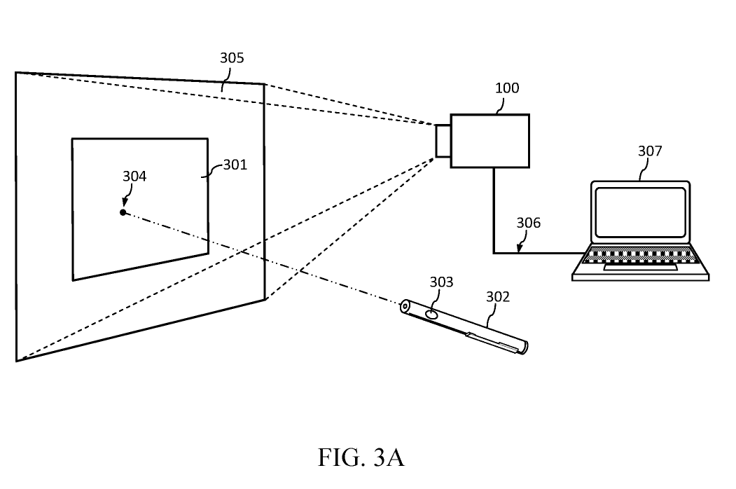

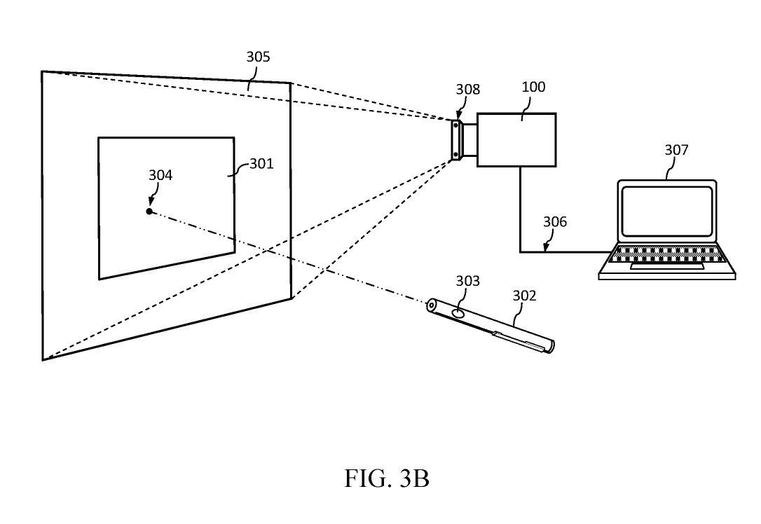

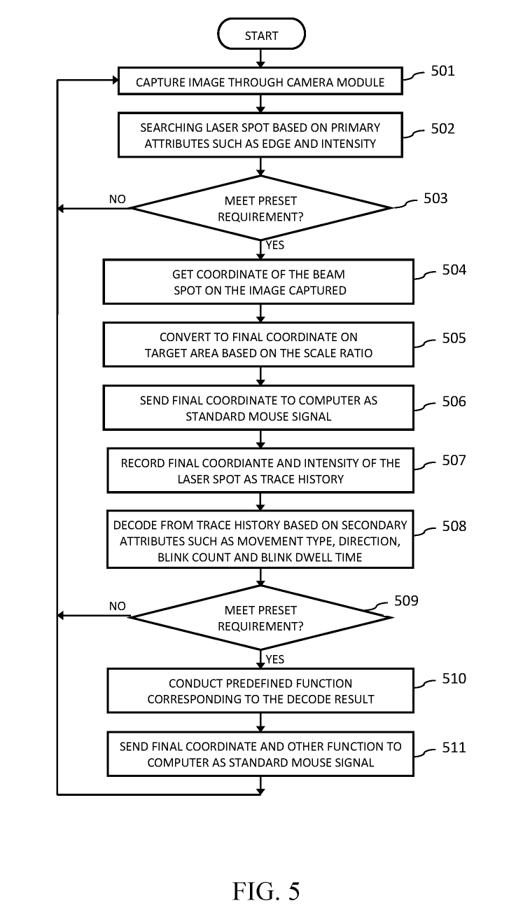

FIG. 3A illustrates an application of the electronic device 100 working in mouse mode. As shown in FIGS. 1, 2A and 3A, the electronic device 100, set in front of target area 301, is connected to a computer 307 via wired or wireless communication interface 306. The target area 301 could CRT monitor, LCD/LED/Plasma display screen of a computer, a TV set, optical projection display screens (front and rear) or any specified area with enough reflectivity at the wavelength of the laser pointer. The view field 305 of the lens 201 should be larger than the target area 301, so that it can cover the entire target area 301. A laser pointer 302 is to work with electronic device 100 to remotely control the computer cursor and perform the mouse functions. Such laser pointer can be any off-the-shelf product as long as its wavelength is in visible range. When the on/off button 302 is pressed down, a laser beam spot 304 is projected to the target area. The camera module 101 will capture the image of the entire view filed 305 which is imposed with the lease beam spot 304. The compounded image is then captured and transferred to the processor 102. The processor 102 will then run image processing program which flow chart is shown in FIG. 5.

As illustrated in FIG. 5, after the compounded image, which composes of both target area and the laser beam spot, is captured by the camera, as present by block 501, the image data is then scanned by the program which will search the location of the laser beam spot, and get its coordinates based on primary attributes such as characteristics of the edge, the shape or the intensity as presented by block 502. The coordinates of the beam spot are now determined for the captured image area which will then be converted into the corresponding coordinates in the target area based on the scale ratio, as illustrated by block 504, 505 and 506. The property data of the beam spot, including coordinate and intensity, is then saved in the memory and serves as the trace pattern as illustrated in block 507. The trace pattern is then analyzed and decoded based on secondary attributes such as direction and scale of the movement and intensity modulation pattern as presented in block 508. As soon as the trace pattern matches any predefined trace pattern, the corresponding mouse function is then activated as presented in block 510. The predefined mouse functions refer to particular mouse button clicking actions such as left button single-click, left button double-click, right button single-click, press-and-drag, scroll up, scroll down, scroll left and scroll right. Such predefined function signals are sent to computer 307 as standard mouse signal.

In the preferred embodiment, the laser pointer 302 produces a laser beam spot 304, which is normally round shaped with a much higher intensity compared with the rest of image intensity in target area and be therefore easily differentiated. FIG. 3B illustrates another setup for the electronic device 100 when a low-powered laser pointer is used. An optical band-pass filter 308, which its pass band wavelength matches the laser pointer 302, is used to depress the intensity of the target area in the captured image so the laser beam spot is easily detected.

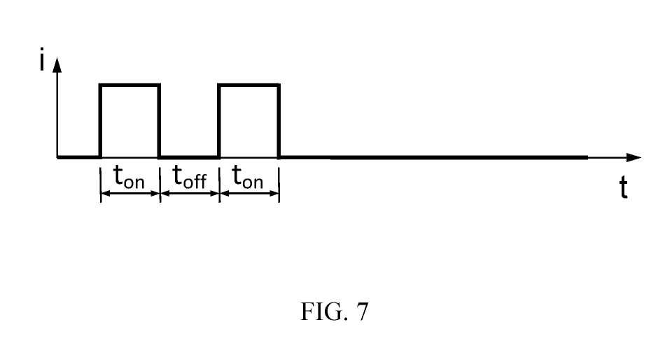

The laser pointer 302 is used to generate one of the secondary attributes to imitate mouse click functions. The secondary attributes include beam spot position, intensity modulation, and beam moving style and so on. In the preferred embodiment, FIG. 7 illustrates one example of attributes which is predefined as mouse left button single-click. In this example, horizontal axis is time while vertical axis is beam spot intensity. tₒₙ is the time interval when the laser pointer 302 is on and t_{off} is the time interval when the laser pointer 302 is off. If the laser pointer 302 is switched on and off twice with equal time while positioned at the same position, the function corresponding to mouse left button single-click is then trigged.

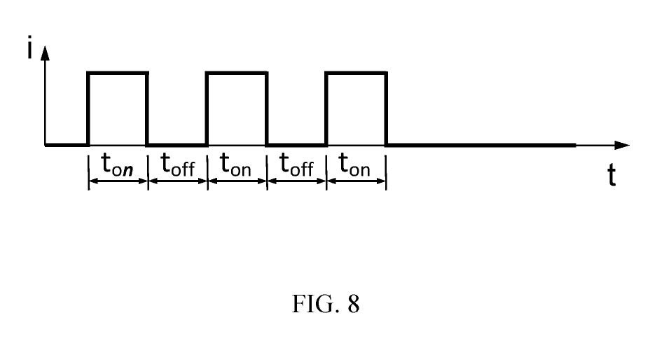

FIG. 8 illustrates one example of attributes which is predefined as mouse left button double-click. In this example, the laser pointer 302 is switched on and off three times at the same position.

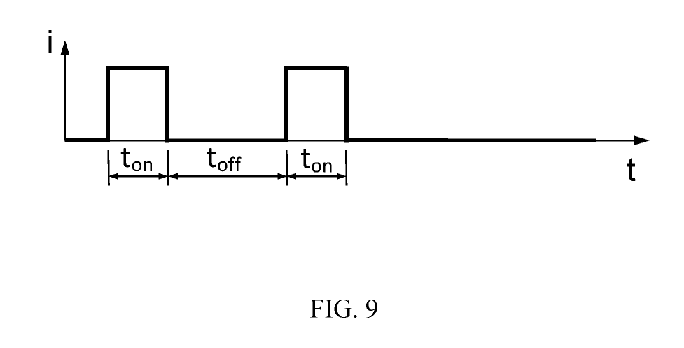

FIG. 9 illustrates one example of attributes which is predefined as mouse right button single-click. In this example, the laser pointer 302 is switched twice at the same position and t_{off} is two times longer than tₒₙ.

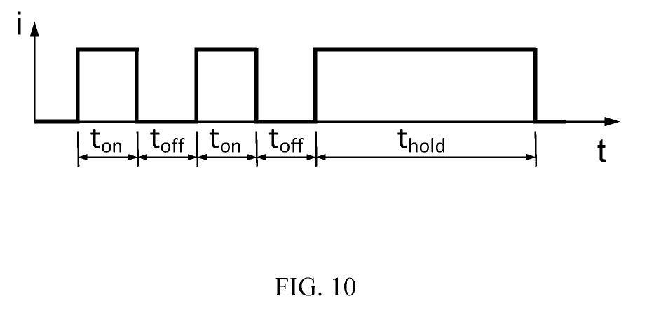

FIG. 10 illustrates one example of attributes which is predefined as mouse drag-drop function. In this example, the laser pointer 302 is switched twice with same time interval (t_{off}=tₒₙ) at the same position and another longer on t_{hold}.

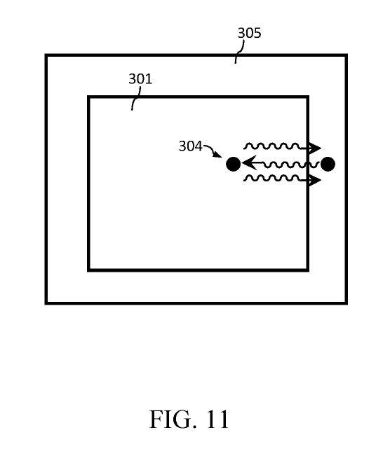

FIG. 11 illustrates one example of attributes which is predefined as mouse scroll-right function. In this example, the beam spot 304 zigzags from inside target area 301 to outside but still inside field of view 305 of the camera module 101.

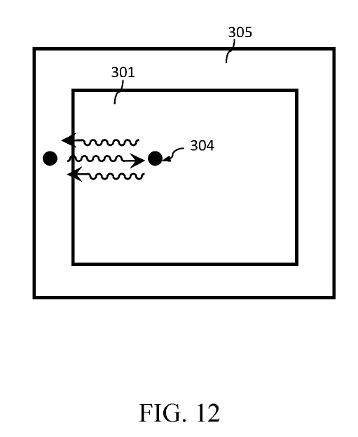

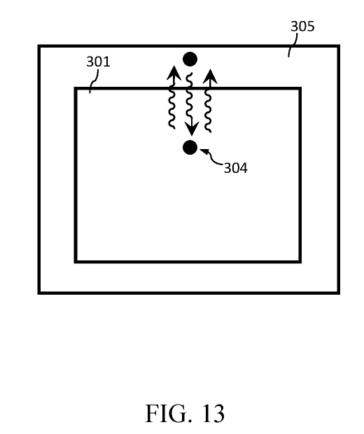

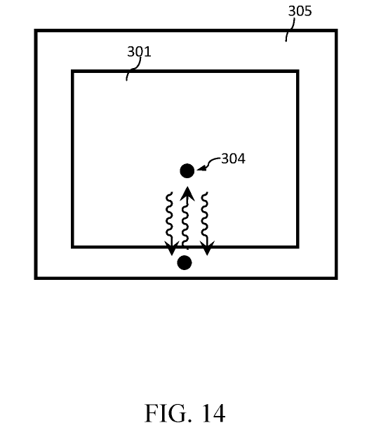

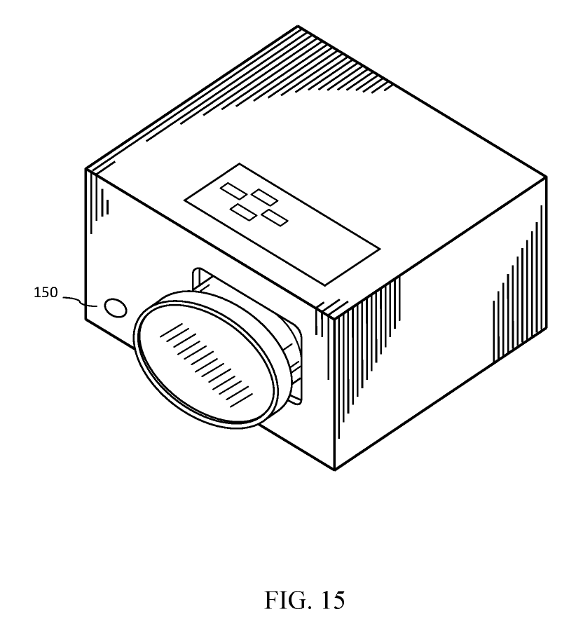

In same principle, FIGS. 12 to 14 illustrate the attributes for mouse scroll-left, scroll up and scroll down correspondingly.

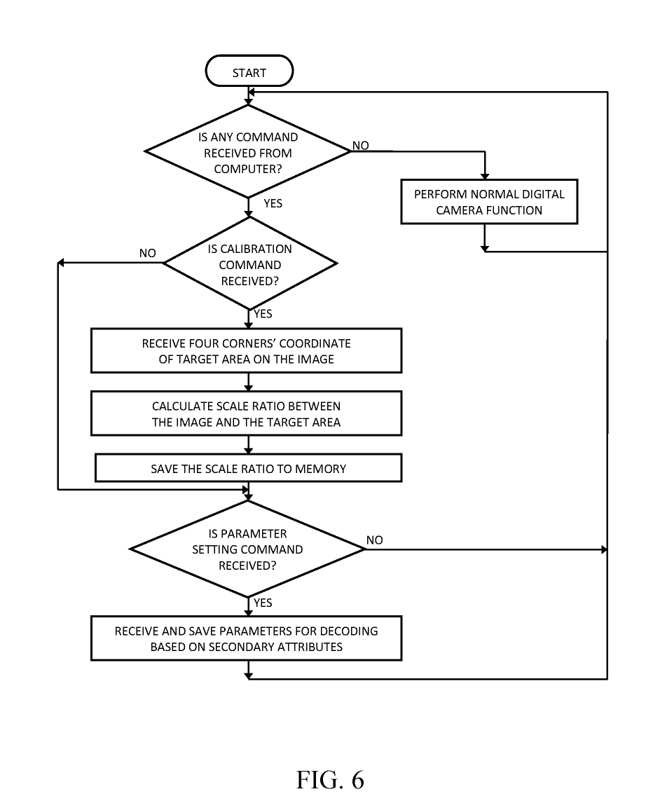

When the switch is set to camera mode, the electronic device 100 will work in camera mode. Referring FIG. 6.

What is claimed is:

1. An apparatus working with a laser pointer to remotely control a computer cursor via standard communication interface, comprising:
a camera module;
one or more processors;
one or more memories for storing data and software programs for image processing;
a communication interface, wired or wireless, with a computer;
a switch to change the working mode;
image processing programs stored in a memory with below functions:
Capturing an image on a target area on where a beam spot of a laser pointer is projected;
Finding the coordinates of a beam spot characterized by one or more primary attributes on the image scale;
Calibrating and transferring beam spot coordinates from captured image to pre-defined target area;
Recording the trace of the beam spot and its dynamic properties;
Recognizing the trace pattern and properties characterized by one or more secondary attributes encoded with commands that are corresponding to specific mouse operations.
Communicating with a computer via standard communication interface.

2. An apparatus as set forth in claim 1, it has two working modes set by the switch: mouse mode and digital camera mode.

3. An apparatus as set forth in claim 1, wherein the laser pointer is an off-the-shelf product with DC optical output. The wavelength should be in visible range, but not specified.

4. An apparatus as set forth in claim 1, wherein the camera module comprising lens, image sensor and pre-processing circuit.

5. An apparatus as set forth in claim 1, wherein the target area could be one of CRT monitor, LCD/LED/Plasma display screen of a computer or TV set, optical projection display screens (front and rear) and any specified area with enough high reflectivity at the wavelength of the laser pointer.

6. An apparatus as set forth in claim 1, wherein the standard communication interface is one of USB (Universal Series Bus), RS232, PS2, blue tooth and Wi-Fi.

7. An apparatus as set forth in claim 1, wherein the primary attributes refer to light intensity and shape of a beam spot.

8. An apparatus as set forth in claim 1, wherein the secondary attributes include beam intensity modulation pattern and pre-defined trace pattern.

9. An apparatus as set forth in claim 3 as an option, further comprising:
A replaceable and removable optical band-pass filter positioned in front of the lens, wherein the filter only transmits the light at the wavelength of the laser pointer.

10. An apparatus as set forth in claim 3 as an option, further comprising:
an IR-cut filter or blue glass, positioned between lens and sensor.

11. An apparatus as set forth in claim 8, wherein the pre-defined trace pattern refers to the movement of the beam spot which is characterized by its direction, speed, and scale.
